(19) United States
(12) Patent Application Publication
(10) Pub. No.: US 2015/0099251 A1
(43) Pub. Date: Apr. 9, 2015

(54) SKI TRAINING HARNESS HAVING RECTRACTABLE LEASHES

(71) Applicant: Duncan Anderson, Calgary (CA)

(72) Inventor: Duncan Anderson, Calgary (CA)

(21) Appl. No.: 14/048,289

(22) Filed: Oct. 8, 2013

(51) Int. Cl. A63B 69/18; A01K 27/00

(52) U.S. Cl. CPC A63B 69/18; A01K 27/002; A01K 27/004; A63B 2208/12
USPC 434/253

(57) ABSTRACT

A ski training harness comprising: (a) an adjustable, releasable waist strap; (b) a pair of retractable leashes connected to the waist strap at a left-side and right-side location relative to a child, wherein each of the retractable leashes comprises a handle adapted to allow an adult wearing ski gloves to easily grasp the leash handle, a portion of each of the leashes extending from each of the handles; and (c) means for securing the pair of leash handles to the waist strap.

### BACKGROUND OF THE INVENTION

1. Technical Field

The present invention relates to a ski training harness for children, which has a pair of retractable leashes.

2. Description of Related Art

Ski training harnesses for children are known in the art. These harnesses typically have a strap which attaches to the harness, allowing an adult skiing behind a child to control the child's downhill speed and direction.

However, ski training harnesses in common use have several disadvantages. For example, some harnesses have a strap that attaches to the harness at the upper back portion, rather than at the waist. These are less suitable for small children because when an adult tugs on the straps they often cause the child to fall backwards. Other harnesses have strap attachment points only at the left and right sides of the waist. This is fine for teaching children to ski, but is not useful for teaching a child to snowboard. Also, the straps of the ski harnesses described to date are of a fixed length. This presents issues with respect to both convenience and safety when the strap is not in use, such as when the child is preparing to get on a chair-lift or gondola. At that point the strap, which is typically 10-20 feet long, either must be rolled up or disconnected from the harness, and held by either the child or an adult assistant. In either case, much care must be taken to ensure that the strap not be allowed to drop or become unrolled as either event can cause a serious safety hazard.

U.S. Pat. No. 4,424040 describes a ski training halter adapted for positioning on a person below his or her waist and to extend across the person's front, lower abdominal region to the respective left and right hip regions of the student's body. The training halter also includes portions adapted to be positioned around the upper portions of the student's thighs and interconnected with the portions extending across the student's lower abdominal and hip regions. Adjustable and detachable fasteners are provided to maintain the training halter in proper, taut position on the person's body, and elongated reins are detachably connected to the training halter and extended to a location rearwardly of the person where another person can be positioned safely on skis to hold the reins and use them to exert restraining and turning forces on the training halter.

U.S. Pat. No. 5,074,795 describes a method for teaching children to ski using a wide torso encircling band and two pairs of reins of different length. At an early stage of learning, the instructor straddles the child and uses short reins to directly control the speed and direction of the child and the pair of ski slowly. At a later stage of learning, the instructor backs away from the child and uses the long reins to directly control the child's speed and indirectly control the child's direction.

U.S. Pat. No. 5,080,191 describes a harness for use by adults or children in learning certain sporting activities such as snow skiing wherein handles are conveniently disposed for gripping by individuals helping a user of the harness. The harness is provided with unique means for positively positioning the harness on a user for optimal control.

Retractable pet leashes provide for variable attachment, in distance, between a pet and the owner. These devices typically have a wind-up spool disposed in a housing with a thumb-actuated brake for controlling the amount of leash to be dispensed.

For example, U.S. Pat. No. 4,501,320 describes a hand-held apparatus which dispenses, retracts and locks an animal leash in a desired position. The apparatus includes a spool housing sized to store a length of cord and a handle portion adapted to be grasped in the hand of a user. The spool housing rotably mounts a spool having the length of cord wrapped thereabout with the distal end of the cord being attachable to an animal collar. A coil spring is mounted between the spool and spool housing to continuously bias the length of cord in a retracted position about the spool. A high strength locking mechanism adapted to selectively apply friction to the spool and positively prevent the cord from being dispensed or retracted from the spool is provided which is actuable by way of a trigger lever formed on the handle portion of the housing. A cam actuator stop is additionally provided to maintain the locking mechanism in a locked orientation.

Also, U.S. Pat. No. 6,688,260 describes a retractable pet leash that can alternatively be held in a user's hand or secured to a belt worn around the user's waist. The leash is retractable inside an enclosure designed to conform generally to the shape of a user's hip or waist. The retractor retracts a first length of leash that has a first connector coupled to its distal end. The first connector can be coupled to a second connector that is coupled to a handle portion of a second length of leash. The connectors allow the user to disconnect the second length of leash from the retractor.

There exists a continuing need for a ski training harness having retractable leashes which may be safely and conveniently secured to the harness when not in use. Ideally, given the increased popularity of snowboarding, the ski training harness also should be adapted such that it is equally useful in teaching children to snowboard. The present invention substantially fulfills this need.

### SUMMARY OF THE INVENTION

The present invention is directed to a ski training harness comprising: (a) an adjustable, releasable waist strap extending horizontally around the waist of a child, the waist strap comprising closure means at each of its two terminal ends for securing the waist strap to a child; (b) a pair of adjustable, removable shoulder straps connected to the waist strap at a front and rear location relative to a child and adapted to extend over a child's shoulders; (c) a back strap interconnecting the shoulder straps at the back of a child, wherein the back strap comprises a handle adapted to allow an adult wearing ski gloves to easily grasp the handle; (d) an adjustable, releasable chest strap interconnecting the shoulder straps at the chest of a child; (e) a pair of adjustable leg straps having opposite ends connected to the waist strap at a front and rear location relative to a child, wherein each of the leg straps is adapted to enclose a child's leg; (f) a pair of retractable leashes connected to the waist strap at a left-side and right-side location relative to a child, wherein each of the retractable leashes comprises a handle adapted to allow an adult wearing ski gloves to easily grasp the leash handle, a portion of each of said leashes extending from each of said handles; and (g) means for securing the pair of leash handles to the waist strap.

The present invention also is directed to a ski training harness comprising: (a) an adjustable, releasable waist strap extending horizontally around the waist of a child, the waist strap comprising closure means at each of its two terminal ends for securing the waist strap to a child; (b) a pair of adjustable leg straps having opposite ends connected to the waist strap at a front and rear location relative to a child, wherein each of the leg straps is adapted to enclose a child's leg; (c) a pair of retractable leashes connected to the waist strap at a front and rear location relative to a child, wherein each of the retractable leashes comprises a handle adapted to allow an adult wearing ski gloves to easily grasp the leash handle, a portion of each of said leashes extending from each of said handles; and (d) means for securing the pair of leash handles to the waist strap.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a front view of a ski training harness of the present invention.

FIG. 2 is a side view of the present invention, illustrating a retractable leash secured in a holster.

FIG. 3 is a side view of a leash handle and retractable leash of the present invention.

FIG. 4 is a front view of the present invention, illustrating the shoulder straps, and the interconnecting chest strap and back strap.

FIG. 5 is a rear view of the present invention.

FIG. 6 is a front view of the waist portion of the present invention.

FIG. 7 is a front view of the leg strap portion of the present invention.

In the following description of the invention similar reference characters refer to similar parts throughout the several views of the drawings.

As used herein the term “ski training harness” refers to ski training harnesses, snowboard training harnesses and harnesses suitable for both skiing and snowboarding training.

### DETAILED DESCRIPTION

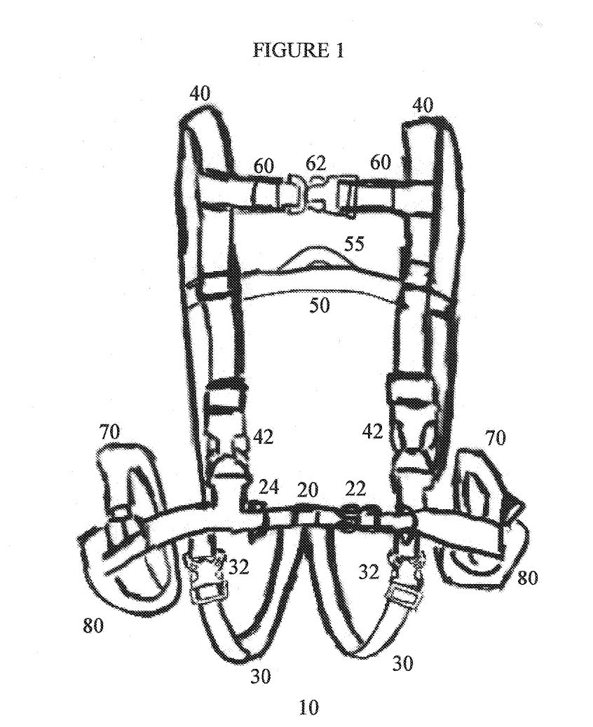

FIG. 1 shows ski training harness 10 having waist strap 20, leg straps 30, shoulder straps 40, back strap 50, chest strap 60, retractable leash handles 70 and holsters 80. Retractable leashes 75 are contained in leash handles 70, and are not shown in FIG. 1. Waist strap 20 is adjustable and has buckle-type fastener 22, which allows waist strap 20 to be secured around the waist of a child. Leash rings 24 are provided at the front, left-side, right-side and back portions of waist strap 20. Leash rings 24 allow a user to clip retractable leashes 75 to waist strap 20. The left-side and right-side leash rings 24 are used when connecting retractable leashes 75 to the waist strap 20 of a skier. Alternatively, the front and back leash rings 24 are used when connecting retractable leashes 75 to the waist strap 20 of a snowboarder.

Shoulder straps 40 extend over the shoulders of a child. Shoulder straps 40 are adjustable and are attached to waist strap 20 with buckle-type fasteners 42 at the front and rear portions of waist strap 20. Back strap 50 interconnects shoulder straps 40 along the upper portion of the back of a child, and contains back strap handle 55. Back strap handle 55 allows an adult to grasp the shoulder strap and lift a child into a standing position or to stabilize a standing child. Back strap handle 55 includes an opening large enough for an adult wearing ski gloves or mittens to easily grasp the handle. Chest strap 60 interconnects should straps 40 at the chest of a child. Chest strap 60 is adjustable and releaseable, and includes buckle-type fastener 62.

Shoulder straps 40 are releaseable from waist strap 20. Therefore, as the child becomes more skilled at skiing and/or snowboarding, the ski harness may be used without shoulder straps 40.

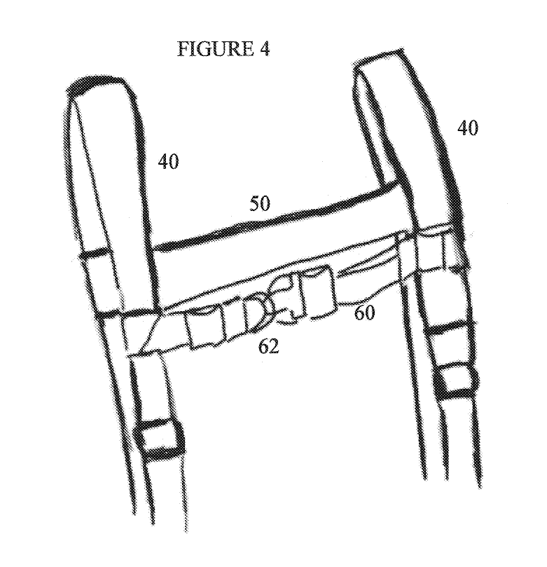

Leg straps 30 fit around the upper portion of a child's legs. Leg straps 30 are adjustable, and are attached to waist strap 20 with buckle-type fasteners 32 at the front portion and with leg straps ring 26 (see FIG. 4) at the rear portion of waist strap 20.

Holsters 80 are secured to the left-side and right-side portions of waist strap 20, and may be used to safely and conveniently store retractable leash handles 70 when not in use. For example, retractable leash handles 70 may be stored in holsters 80 when a child wearing ski harness 10 is preparing to get on a ski chair-lift or gondola.

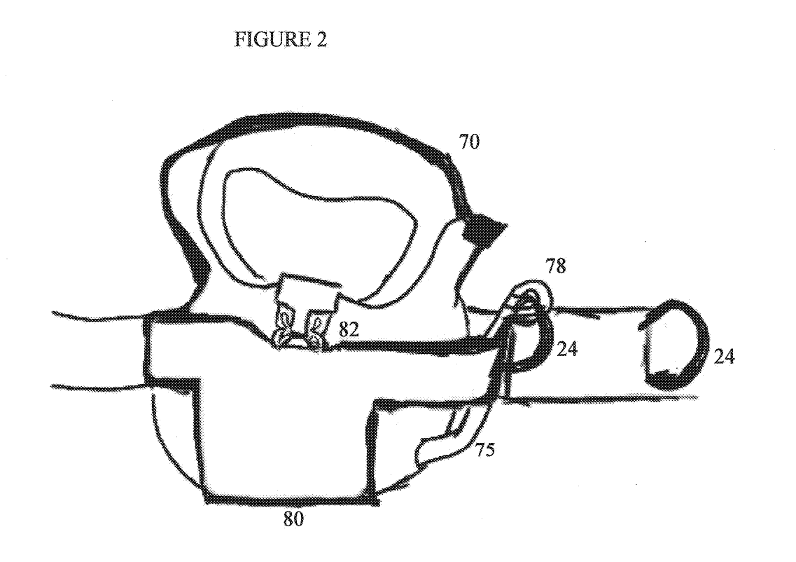

FIG. 2 shows a side view of waist strap 20 having leash rings 24 and holster 80. Leash handle 70 is stored within holster 80. Retractable leash 75 is shown in its retracted position and is attached to waist strap 20 using leash clip 78, which is located at the terminal portion of retractable leash 75, and leash ring 24. Holster 80 includes buckle-type fastener 82 for securing leash handle 70 within holster 80.

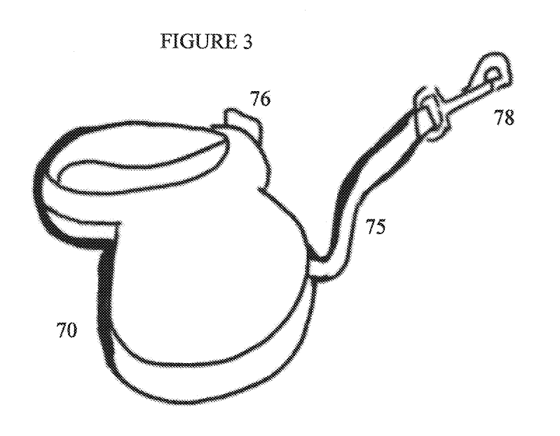

FIG. 3 shows a side view of leash handle 70 having retractable leash 75 in a partially extended position and thumb actuated brake 76. Thumb actuated brake 76 allows leash 75 to be locked at fixed extension lengths relative to leash handle 70. FIG. 3 also shows leash clip 78, which is located at the terminal portion of retractable leash 75.

FIG. 4 shows a front view of shoulder straps 40, back strap 50, which interconnects shoulder straps 40 along the upper portion of the back of a child, and chest strap 60, which interconnects should straps 40 at the chest of a child. Chest strap 60 is adjustable and releaseable, and includes buckle-type fastener 62.

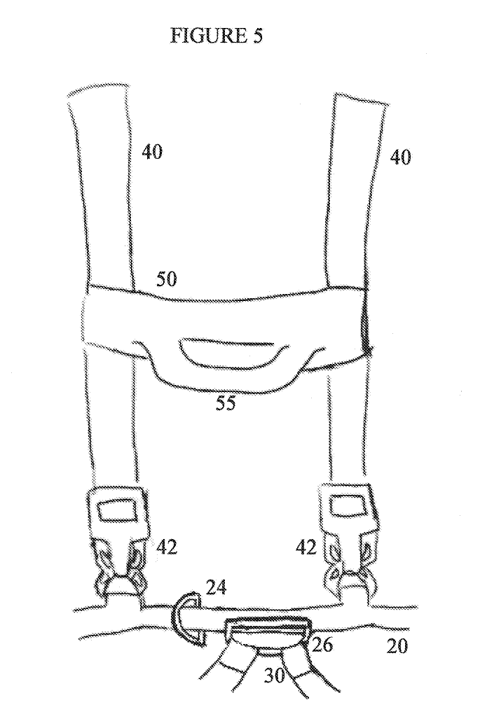

FIG. 5 shows a rear view of shoulder straps 40, back strap 50, which interconnects shoulder straps 40 along the upper portion of the back of a child, and back strap handle 55. FIG. 5 also shows buckle-type fasteners 42, which connect shoulder straps 40 to waist strap 20, as well as back leash ring 24, leg strap ring 26 and leg straps 30. Back leash rings 24 is used, along with front leash ring 24 (see FIG. 1) when connecting retractable leashes 75 to the waist strap 20 of a snowboarder. Leg strap ring 26 is used for securing leg straps 30 to the back portion of waist strap 20.

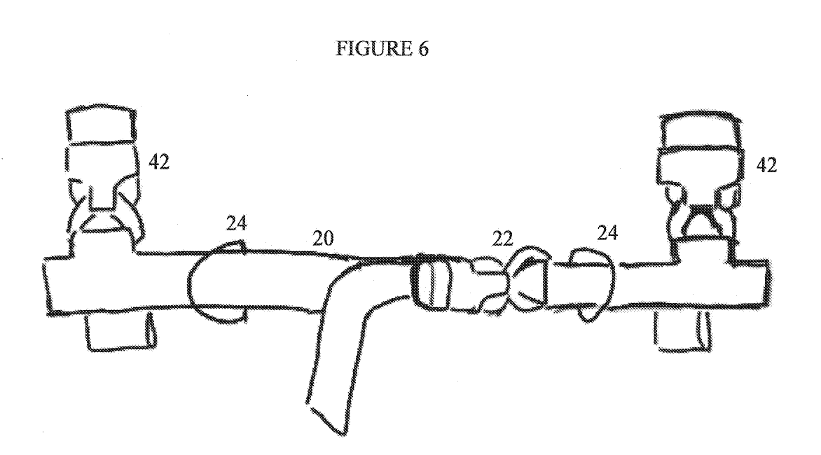

FIG. 6 shows the front portion of waist strap 20. Waist strap 20 includes, along its front portion, buckle-type fastener 22, leash rings 24. FIG. 6 also show buckle-type fasteners 42, which connect shoulder straps 40 (see FIG. 1) to waist strap 20 at the front portion of waist strap 20. One of leash rings 24 located on the front of waist strap 20 is used, along with back leash ring 24 (see FIG. 5), when connecting retractable leashes 75 to the waist strap 20 of a snowboarder.

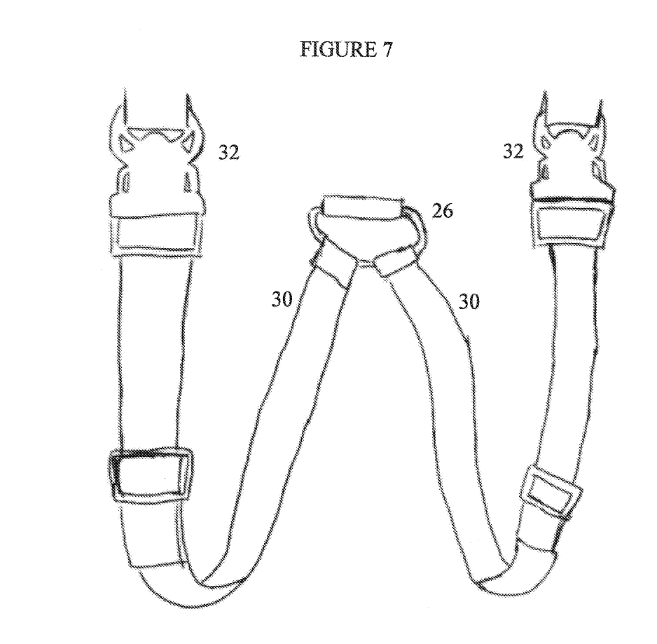

FIG. 7 shows a front view of leg straps 30 while not showing waist strap 20 to which it is attached. Leg straps 30 are attached to waist strap 20 with buckle-type fasteners 32 at the front portion and with leg straps ring 26 at the rear portion of waist strap 20.

In the embodiments of the present invention illustrated in FIGS. 1-7 and described above, buckle-type fasteners are used for securing strap ends to one another. Thus, waist strap 20 contains buckle-type fastener 22, leg straps 30 contain buckle-type fasteners 32, shoulder straps 40 contain buckle-type fasteners 42, chest strap 60 contains buckle-type fastener 62 and holsters 80 contain buckle-type fasteners 82. Of course, any mechanical fastener which facilitates connecting strap ends to one another may be used in place of buckle-type fasteners. Such alternative mechanical fasteners include, for example, hook-and-loop fasteners, clips, buttons or any combination thereof.

While particular embodiments of the present invention have been shown and described herein for purposes of illustration, it will be understood that the invention is not limited thereto. Modifications may be made by persons skilled in the art, particularly in light of the foregoing teachings, without deviating from the spirit and scope of the invention. Accordingly, the invention is not limited except as by the appended claims.

All of the U.S. patents referred to in this specification are incorporated herein by reference in their entirety to the extent not inconsistent with the present description.

What is claimed is:

1. A ski training harness comprising:
(a) an adjustable, releasable waist strap extending horizontally around the waist of a child, said waist strap comprising closure means at each of its two terminal ends for securing said waist strap to a child;
(b) a pair of adjustable, removable shoulder straps connected to said waist strap at a front and rear location relative to a child and adapted to extend over a child's shoulders;
(c) a back strap interconnecting said shoulder straps at the back of a child, wherein said back strap comprises a handle adapted to allow an adult wearing ski gloves to easily grasp said handle;
(d) an adjustable, releasable chest strap interconnecting said shoulder straps at the chest of a child;
(e) a pair of adjustable leg straps having opposite ends connected to said waist strap at a front and rear location relative to a child, wherein each of said leg straps is adapted to enclose a child's leg;
(f) a pair of retractable leashes connected to said waist strap at a left-side and right-side location relative to a child, wherein each of said retractable leashes comprises a handle adapted to allow an adult wearing ski gloves to easily grasp said leash handle, a portion of each of said leashes extending from each of said handles; and
(g) means for securing said pair of leash handles to said waist strap.

2. A ski training harness according to claim 1, wherein said pair of retractable leashes is removable from said waist strap.

3. A ski training harness according to claim 2, wherein said means for securing said pair of leash handles to said waist strap comprises a pair of holsters connected to said waist strap at a left-side and right-side location relative to a child, wherein each of said holsters is adapted to hold a leash handle.

4. A ski training harness according to claim 3, wherein each of said holsters comprises means for securing said leash handle within said holster.

5. A ski training harness according to claim 4, wherein said means for securing said leash handle within said holster comprises a restraining strap connected to said holster on opposite sides thereof and wherein said restraining strap is adapted to pass through the leash handle opening.

6. A ski training harness according to claim 5, wherein said restraining strap comprises a buckle-type fastener.

7. A ski training harness according to claim 5, wherein said restraining strap comprises a hook-and-loop fastener.

8. A ski training harness according to claim 1, wherein each of said leash handles comprises a rotational spool mounted within said leash handle and wherein said retractable leash is wound around said spool.

9. A ski training harness according to claim 8, wherein each of said leash handles comprises means for locking each of said retractable leash at fixed extension lengths relative to said handle.

10. A ski training harness according to claim 9, wherein said means for locking said retractable leash at fixed lengths comprises a break configured to prevent rotation of said spool.

11. A ski training harness comprising:
(a) an adjustable, releasable waist strap extending horizontally around the waist of a child, said waist strap comprising closure means at each of its two terminal ends for securing said waist strap to a child;
(b) a pair of adjustable leg straps having opposite ends connected to said waist strap at a front and rear location relative to a child, wherein each of said leg straps is adapted to enclose a child's leg;
(c) a pair of retractable leashes connected to said waist strap at a front and rear location relative to a child, wherein each of said retractable leashes comprises a handle adapted to allow an adult wearing ski gloves to easily grasp said leash handle, a portion of each of said leashes extending from each of said handles; and
(d) means for securing said pair of leash handles to said waist strap.

12. A ski training harness according to claim 11, wherein said pair of retractable leashes is removable from said waist strap.

13. A ski training harness according to claim 12, wherein said means for securing said pair of leash handles to said waist strap comprises a pair of holsters connected to said waist strap at a left-side and right-side location relative to a child, wherein each of said holsters is adapted to hold a leash handle.

14. A ski training harness according to claim 13, wherein each of said holsters comprises means for securing said leash handle within said holster.

15. A ski training harness according to claim 14, wherein said means for securing said leash handle within said holster comprises a restraining strap connected to said holster on opposite sides thereof and wherein said restraining strap is adapted to pass through the leash handle opening.

16. A ski training harness according to claim 15, wherein said restraining strap comprises a buckle-type fastener.

17. A ski training harness according to claim 15, wherein said restraining strap comprises a hook-and-loop fastener.

18. A ski training harness according to claim 11, wherein each of said leash handles comprises a rotational spool mounted within said leash handle and wherein said retractable leash is wound around said spool.

19. A ski training harness according to claim 18, wherein each of said leash handles comprises means for locking each of said retractable leash at fixed extension lengths relative to said handle.

20. A ski training harness according to claim 19, wherein said means for locking said retractable leash at fixed lengths comprises a break configured to prevent rotation of said spool.
